(19) United States
(12) Patent Application Publication
(10) Pub. No.: US 2016/0293102 A1
(43) Pub. Date: Oct. 6, 2016

(54) SYSTEMS AND METHODS OF DISPLAY BRIGHTNESS ADJUSTMENT

(71) Applicant: Ignis Innovation Inc., Waterloo (CA)

(72) Inventor: Gholamreza Chaji, Waterloo (CA)

(21) Appl. No.: 15/086,217

(22) Filed: Mar. 31, 2016

(30) Foreign Application Priority Data
Apr. 1, 2015 (CA) 2886862

(51) Int. Cl. G09G 3/3225; H05B 33/08; H05B 37/02

(52) U.S. Cl. CPC G09G 3/3225; H05B 37/0227; H05B 33/0896; G09G 2320/041; G09G 2320/048; G09G 2330/045

(57) ABSTRACT

Systems and methods for adjusting a brightness of a display panel by periodically measuring at least one physical property in at least one area of a display panel, generating measurement data, and adjusting the brightness of the display panel with use of the measurement data. The brightness can be adjusted to control temperature and aging, in response to measurements of physical properties measured in at least one area of the display panel.

### CROSS-REFERENCE TO RELATED APPLICATION(S)

This application claims priority to Canadian Patent Application No. 2,886,862, filed Apr. 1, 2015, which is hereby incorporated by reference herein in its entirety.

### FIELD OF THE INVENTION

The present disclosure relates to managing of aging and deterioration of light emissive visual display technology, and particularly to systems and methods for display temperature and aging monitoring and management through brightness control for active matrix light emitting diode device (AMOLED) and other emissive displays.

### BRIEF SUMMARY

According to a first aspect there is provided a method of adjusting a brightness of an emissive display system including: periodically measuring at least one physical property in at least one area of a display panel generating measurement data; and adjusting the brightness of the display panel with use of the measurement data.

In some embodiments the measurement data comprises measurements of each at least one physical property, the embodiment further providing for: comparing each measurement of each at least one physical property with at least one threshold generating a respective at least one comparison, wherein adjusting the brightness of the display panel is performed with use of the at least one comparison.

Some embodiment further provide for: predicting the future state of at least one physical property with use of the measurement data generating at least one predicted physical property value; and comparing the at least one predicted physical property value with at least one threshold generating a respective at least one comparison, wherein adjusting the brightness of the display panel is performed with use of the at least one comparison.

In some embodiments, adjusting the brightness of the display panel comprises determining a target brightness for the display panel with use of the measurement data, wherein the target brightness falls within at least one acceptable range of brightness.

In some embodiments, adjusting the brightness of the display panel comprises determining a target brightness for the display panel with use of the measurement data, wherein the target brightness falls within at least one acceptable range of brightness.

In some embodiments the at least one physical property comprises a rate of temperature change and the at least one threshold comprises a first threshold rate of temperature change and a second threshold rate of temperature change, wherein adjusting the brightness of the display panel comprises: determining the target brightness to be lower than a current brightness when the at least one comparison indicates that the rate of temperature change is greater than the first threshold rate of temperature change and when the current brightness is greater than a minimum acceptable brightness of said at least one acceptable range of brightness; and determining the target brightness to be higher than the current brightness when the at least one comparison indicates that the rate of temperature change is greater than the second threshold rate of temperature change, and when the current brightness is less than a maximum acceptable brightness of said at least one acceptable range of brightness.

In some embodiments, the at least one physical property comprises a temperature and the at least one threshold comprises a first threshold temperature and a second threshold temperature, wherein adjusting the brightness of the display panel comprises: determining the target brightness to be lower than a current brightness when the at least one comparison indicates that the temperature is greater than the first threshold temperature and when the current brightness is greater than a minimum acceptable brightness of said at least one acceptable range of brightness; and determining the target brightness to be higher than the current brightness when the at least one comparison indicates that the temperature is greater than the second threshold temperature, and when the current brightness is less than a maximum acceptable brightness of said at least one acceptable range of brightness.

In some embodiments, the at least one physical property comprises a rate of temperature change and a temperature and the at least one threshold comprises a threshold rate of temperature change a threshold temperature, wherein adjusting the brightness of the display panel comprises: determining the target brightness to be lower than a current brightness when the at least one comparison indicates that the rate of temperature change is greater than the threshold rate of temperature change and the temperature is greater than the first threshold temperature and when the current brightness is greater than a minimum acceptable brightness of said at least one acceptable range of brightness; and determining the target brightness to be higher than the current brightness when the at least one comparison indicates that at least one of the rate of temperature change is not greater than the threshold rate of temperature change and the temperature is not greater than the second threshold temperature, and when the current brightness is less than a maximum acceptable brightness of said at least one acceptable range of brightness.

In some embodiments, the at least one physical property comprises a rate of temperature change and a temperature, the at least one predicted physical property value comprises a predicted temperature value, and the at least one threshold comprises a first threshold temperature and a second threshold temperature, wherein adjusting the brightness of the display panel comprises: determining the target brightness to be lower than a current brightness when the at least one comparison indicates that the predicted temperature value is greater than the first threshold temperature and when the current brightness is greater than a minimum acceptable brightness of said at least one acceptable range of brightness; and determining the target brightness to be higher than the current brightness when the at least one comparison indicates that the predicted temperature value is not greater than the second threshold temperature, and when the current brightness is less than a maximum acceptable brightness of said at least one acceptable range of brightness.

In some embodiments, the at least one physical property comprises a rate of aging and the at least one threshold comprises a first threshold rate of aging and a second threshold rate of aging, wherein adjusting the brightness of the display panel comprises: determining the target brightness to be lower than a current brightness when the at least one comparison indicates that the rate of aging is greater than the first threshold rate of aging and when the current brightness is greater than a minimum acceptable brightness of said at least one acceptable range of brightness; and determining the target brightness to be higher than the current brightness when the at least one comparison indicates that the rate of aging is greater than the second threshold rate of aging, and when the current brightness is less than a maximum acceptable brightness of said at least one acceptable range of brightness.

In some embodiments, the at least one physical property comprises aging and the at least one threshold comprises a first threshold aging and a second threshold aging, wherein adjusting the brightness of the display panel comprises: determining the target brightness to be lower than a current brightness when the at least one comparison indicates that the aging is greater than the first threshold aging and when the current brightness is greater than a minimum acceptable brightness of said at least one acceptable range of brightness; and determining the target brightness to be higher than the current brightness when the at least one comparison indicates that the aging is greater than the second threshold aging, and when the current brightness is less than a maximum acceptable brightness of said at least one acceptable range of brightness.

In some embodiments, the at least one physical property comprises aging and a rate of aging the at least one threshold comprises a plurality of aging thresholds and a corresponding plurality of threshold aging rates, wherein adjusting the brightness of the display panel comprises: determining the target brightness when the at least one comparison indicates that the aging is greater than the one of the plurality of aging threshold and the rate of aging is greater than the corresponding one of the plurality of threshold aging rates.

According to a second aspect there is provided a display system comprising: a display panel having an array of pixels that each include a drive transistor and a light emitting device, multiple select lines coupled to said array for delivering signals that select when each pixel is to be driven, multiple data lines for delivering drive signals to the selected pixels, and multiple monitor lines for conveying signals from each pixel; and a monitor system for periodically measuring at least one physical property in at least one area of the display with use of signals over the monitor lines to pixels of the at least one area generating measurement data; a memory store for storing the measurement data; and a controller adapted to adjust the brightness of the display panel with use of the measurement data.

In some embodiments, the measurement data comprises measurements of each at least one physical property, the controller further adapted to: compare each measurement of each at least one physical property with at least one threshold generating a respective at least one comparison, wherein the controller is adapted to adjust the brightness of the display panel with use of the at least one comparison.

In some embodiments, the controller is further adapted to: predict the future state of at least one physical property with use of the measurement data generating at least one predicted physical property value; and compare the at least one predicted physical property value with at least one threshold generating a respective at least one comparison, wherein the controller is adapted to adjust the brightness of the display panel with use of the at least one comparison.

In some embodiments, the controller is adapted to adjust the brightness of the display panel by determining a target brightness for the display panel with use of the measurement data, wherein the target brightness falls within at least one acceptable range of brightness.

In some embodiments, the controller is adapted to adjust the brightness of the display panel by determining a target brightness for the display panel with use of the measurement data, wherein the target brightness falls within at least one acceptable range of brightness.

In some embodiments, the at least one physical property comprises a rate of temperature change and the at least one threshold comprises a first threshold rate of temperature change and a second threshold rate of temperature change, wherein the controller is adapted to adjust the brightness of the display panel by: determining the target brightness to be lower than a current brightness when the at least one comparison indicates that the rate of temperature change is greater than the first threshold rate of temperature change and when the current brightness is greater than a minimum acceptable brightness of said at least one acceptable range of brightness; and determining the target brightness to be higher than the current brightness when the at least one comparison indicates that the rate of temperature change is less than the second threshold rate of temperature change, and when the current brightness is less than a maximum acceptable brightness of said at least one acceptable range of brightness.

In some embodiments, the at least one physical property comprises a temperature and the at least one threshold comprises a first threshold temperature and a second threshold temperature, wherein the controller is adapted to adjust the brightness of the display panel by: determining the target brightness to be lower than a current brightness when the at least one comparison indicates that the temperature is greater than the first threshold temperature and when the current brightness is greater than a minimum acceptable brightness of said at least one acceptable range of brightness; and determining the target brightness to be higher than the current brightness when the at least one comparison indicates that the temperature is less than the second threshold temperature, and when the current brightness is less than a maximum acceptable brightness of said at least one acceptable range of brightness.

In some embodiments, the at least one physical property comprises a rate of temperature change and a temperature and the at least one threshold comprises a threshold rate of temperature change a threshold temperature, wherein the controller is adapted to adjust the brightness of the display panel by: determining the target brightness to be lower than a current brightness when the at least one comparison indicates that the rate of temperature change is greater than the threshold rate of temperature change and the temperature is greater than the threshold temperature and when the current brightness is greater than a minimum acceptable brightness of said at least one acceptable range of brightness; and determining the target brightness to be higher than the current brightness when the at least one comparison indicates that at least one of the rate of temperature change is not greater than the threshold rate of temperature change and the temperature is not greater than the threshold temperature, and when the current brightness is less than a maximum acceptable brightness of said at least one acceptable range of brightness.

In some embodiments, the at least one physical property comprises a rate of temperature change and a temperature, the at least one predicted physical property value comprises a predicted temperature value, and the at least one threshold comprises a first threshold temperature and a second threshold temperature, wherein the controller is adapted to adjust the brightness of the display panel by: determining the target brightness to be lower than a current brightness when the at least one comparison indicates that the predicted temperature value is greater than the first threshold temperature and when the current brightness is greater than a minimum acceptable brightness of said at least one acceptable range of brightness; and determining the target brightness to be higher than the current brightness when the at least one comparison indicates that the predicted temperature value is less than the second threshold temperature, and when the current brightness is less than a maximum acceptable brightness of said at least one acceptable range of brightness.

In some embodiments, the at least one physical property comprises a rate of aging and the at least one threshold comprises a first threshold rate of aging and a second threshold rate of aging, wherein the controller is adapted to adjust the brightness of the display panel by: determining the target brightness to be lower than a current brightness when the at least one comparison indicates that the rate of aging is greater than the first threshold rate of aging and when the current brightness is greater than a minimum acceptable brightness of said at least one acceptable range of brightness; and determining the target brightness to be higher than the current brightness when the at least one comparison indicates that the rate of aging is less than the second threshold rate of aging, and when the current brightness is less than a maximum acceptable brightness of said at least one acceptable range of brightness.

In some embodiments, the at least one physical property comprises aging and the at least one threshold comprises a first threshold aging and a second threshold aging, wherein the controller is adapted to adjust the brightness of the display panel by: determining the target brightness to be lower than a current brightness when the at least one comparison indicates that the aging is greater than the first threshold aging and when the current brightness is greater than a minimum acceptable brightness of said at least one acceptable range of brightness; and determining the target brightness to be higher than the current brightness when the at least one comparison indicates that the aging is greater than the second threshold aging, and when the current brightness is less than a maximum acceptable brightness of said at least one acceptable range of brightness.

In some embodiments, the at least one physical property comprises aging and a rate of aging the at least one threshold comprises a plurality of aging thresholds and a corresponding plurality of threshold aging rates, wherein the controller is adapted to adjust the brightness of the display panel by determining the target brightness when the at least one comparison indicates that the aging is greater than the one of the plurality of aging threshold and the rate of aging is greater than the corresponding one of the plurality of threshold aging rates.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates an example display system in which management of temperature and aging though brightness control is implemented;

FIG. 2 illustrates a method employed by the system for management of temperature stability, aging, and optimal brightness through brightness control;

FIG. 3 illustrates a method employed by the system for management of absolute temperature, aging, and optimal brightness through brightness control;

FIG. 4 illustrates a method employed by the system for management of temperature stability, absolute temperature, aging, and optimal brightness through brightness control;

FIG. 5 illustrates a method employed by the system for management of optimal brightness and aging, avoiding overheating through predictive analysis and brightness control;

FIG. 6 illustrates a method employed by the system for management of the aging rate and optimal brightness through brightness control;

FIG. 7 illustrates a method employed by the system for management of absolute aging and optimal brightness through brightness control;

FIG. 8 illustrates another method employed by the system for management of absolute aging and optimal brightness through brightness control; and

FIG. 9 illustrates a further method employed by the system for management of absolute aging and optimal brightness through brightness control.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Many modern display technologies suffer from an inherent performance-degradation trade-off. Image quality and performance is improved with higher display brightness, however, higher display brightness generally causes greater rates of degradation and aging of the display, compromising its ability to produce images. In emissive displays, higher brightness causes a temperature increase which can rapidly cause faster aging.

The systems and methods disclosed below address this dilemma through monitoring of temperature and aging and the management of display brightness to simultaneously address image quality while preventing or slowing the self-destruction of the display.

While the embodiments described herein will be in the context of AMOLED displays it should be understood that the temperature and aging monitoring and management through display brightness control described herein are applicable to any other display comprising pixels subject to aging and deterioration due to brightness and/or temperature, including but not limited to light emitting diode displays (LED), electroluminescent displays (ELD), organic light emitting diode displays (OLED), plasma display panels (PSP), among other displays.

It should be understood that the embodiments described herein pertain to systems and methods of temperature and aging management through display brightness control and do not limit the display technology underlying their operation and the operation of the displays in which they are implemented. The systems and methods described herein are applicable to any number of various types and implementations of various visual display technologies.

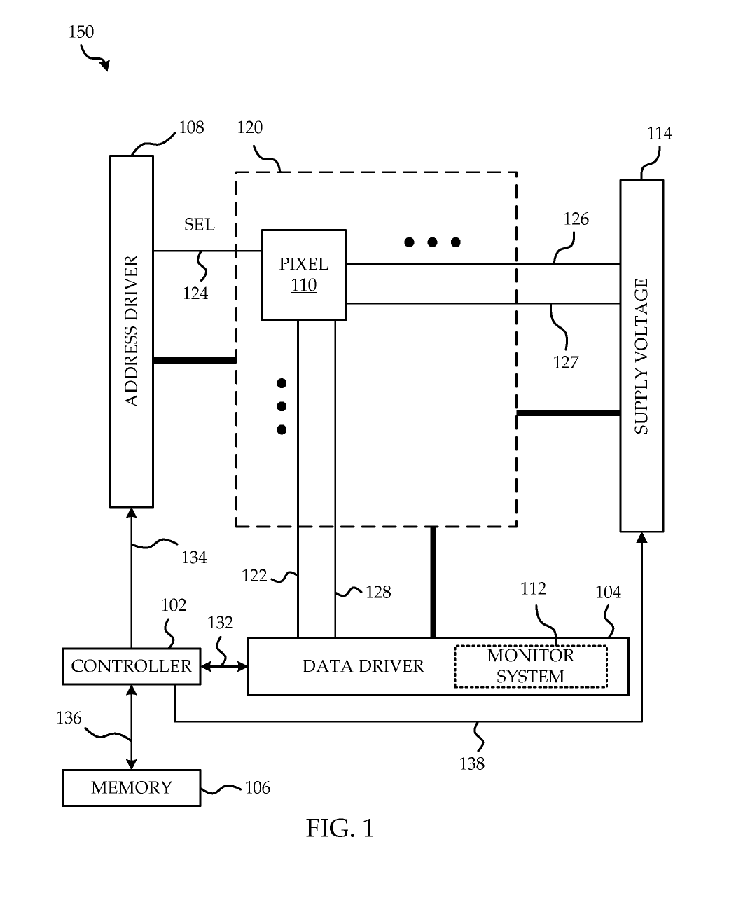

FIG. 1 is a diagram of an example display system 150 implementing the methods described further below. The display system 150 includes a display panel 120, an address driver 108, a data driver 104, a controller 102, and a memory storage 106.

The display panel 120 includes an array of pixels 110 (only one explicitly shown) arranged in rows and columns. Each of the pixels 110 is individually programmable to emit light with individually programmable luminance values. The controller 102 receives digital data indicative of information to be displayed on the display panel 120. The controller 102 sends signals 132 to the data driver 104 and scheduling signals 134 to the address driver 108 to drive the pixels 110 in the display panel 120 to display the information indicated. The plurality of pixels 110 of the display panel 120 thus comprise a display array or display screen adapted to dynamically display information according to the input digital data received by the controller 102. The display screen and various subsets of its pixels define “display areas” which may be used for monitoring and managing display brightness. The display screen can display images and streams of video information from data received by the controller 102. The supply voltage 114 provides a constant power voltage or can serve as an adjustable voltage supply that is controlled by signals from the controller 102. The display system 150 can also incorporate features from a current source or sink (not shown) to provide biasing currents to the pixels 110 in the display panel 120 to thereby decrease programming time for the pixels 110.

For illustrative purposes, only one pixel 110 is explicitly shown in the display system 150 in FIG. 1. It is understood that the display system 150 is implemented with a display screen that includes an array of a plurality of pixels, such as the pixel 110, and that the display screen is not limited to a particular number of rows and columns of pixels. For example, the display system 150 can be implemented with a display screen with a number of rows and columns of pixels commonly available in displays for mobile devices, monitor-based devices, and/or projection-devices.

The pixel 110 is operated by a driving circuit or pixel circuit that generally includes a driving transistor and a light emitting device. Hereinafter the pixel 110 may refer to the pixel circuit. The light emitting device can optionally be an organic light emitting diode, but implementations of the present disclosure apply to pixel circuits having other electroluminescence devices, including current-driven light emitting devices and those listed above. The driving transistor in the pixel 110 can optionally be an n-type or p-type amorphous silicon thin-film transistor, but implementations of the present disclosure are not limited to pixel circuits having a particular polarity of transistor or only to pixel circuits having thin-film transistors. The pixel circuit 110 can also include a storage capacitor for storing programming information and allowing the pixel circuit 110 to drive the light emitting device after being addressed. Thus, the display panel 120 can be an active matrix display array.

As illustrated in FIG. 1, the pixel 110 illustrated as the top-left pixel in the display panel 120 is coupled to a select line 124, a supply line 126, a data line 122, and a monitor line 128. A read line may also be included for controlling connections to the monitor line. In one implementation, the supply voltage 114 can also provide a second supply line to the pixel 110. For example, each pixel can be coupled to a first supply line 126 charged with Vdd and a second supply line 127 coupled with Vss, and the pixel circuits 110 can be situated between the first and second supply lines to facilitate driving current between the two supply lines during an emission phase of the pixel circuit. It is to be understood that each of the pixels 110 in the pixel array of the display 120 is coupled to appropriate select lines, supply lines, data lines, and monitor lines. It is noted that aspects of the present disclosure apply to pixels having additional connections, such as connections to additional select lines, and to pixels having fewer connections.

With reference to the pixel 110 of the display panel 120, the select line 124 is provided by the address driver 108, and can be utilized to enable, for example, a programming operation of the pixel 110 by activating a switch or transistor to allow the data line 122 to program the pixel 110. The data line 122 conveys programming information from the data driver 104 to the pixel 110. For example, the data line 122 can be utilized to apply a programming voltage or a programming current to the pixel 110 in order to program the pixel 110 to emit a desired amount of luminance. The programming voltage (or programming current) supplied by the data driver 104 via the data line 122 is a voltage (or current) appropriate to cause the pixel 110 to emit light with a desired amount of luminance according to the digital data received by the controller 102. The programming voltage (or programming current) can be applied to the pixel 110 during a programming operation of the pixel 110 so as to charge a storage device within the pixel 110, such as a storage capacitor, thereby enabling the pixel 110 to emit light with the desired amount of luminance during an emission operation following the programming operation. For example, the storage device in the pixel 110 can be charged during a programming operation to apply a voltage to one or more of a gate or a source terminal of the driving transistor during the emission operation, thereby causing the driving transistor to convey the driving current through the light emitting device according to the voltage stored on the storage device.

Generally, in the pixel 110, the driving current that is conveyed through the light emitting device by the driving transistor during the emission operation of the pixel 110 is a current that is supplied by the first supply line 126 and is drained to a second supply line 127. The first supply line 126 and the second supply line 127 are coupled to the voltage supply 114. The first supply line 126 can provide a positive supply voltage (e.g., the voltage commonly referred to in circuit design as “Vdd”) and the second supply line 127 can provide a negative supply voltage (e.g., the voltage commonly referred to in circuit design as “Vss”). Implementations of the present disclosure can be realized where one or the other of the supply lines (e.g., the supply line 127) is fixed at a ground voltage or at another reference voltage.

The display system 150 also includes a monitoring system 112. With reference again to the pixel 110 of the display panel 120, the monitor line 128 connects the pixel 110 to the monitoring system 112. The monitoring system 12 can be integrated with the data driver 104, or can be a separate stand-alone system. In particular, the monitoring system 112 can optionally be implemented by monitoring the current and/or voltage of the data line 122 during a monitoring operation of the pixel 110, and the monitor line 128 can be entirely omitted. The monitor line 128 allows the monitoring system 112 to measure a current or voltage associated with the pixel 110 and thereby extract information indicative of a degradation or aging of the pixel 110 or indicative of a temperature of the pixel 110. In some embodiment, display panel 120 includes temperature sensing circuitry devoted to sensing temperature implemented in the pixels 110, while in other embodiments, the pixels 110 comprise circuitry which participates in both sensing temperature and driving the pixels. For example, the monitoring system 112 can extract, via the monitor line 128, a current flowing through the driving transistor within the pixel 110 and thereby determine, based on the measured current and based on the voltages applied to the driving transistor during the measurement, a threshold voltage of the driving transistor or a shift thereof.

The monitoring system 112 can also extract an operating voltage of the light emitting device (e.g., a voltage drop across the light emitting device while the light emitting device is operating to emit light). The monitoring system 112 can then communicate signals 132 to the controller 102 and/or the memory 106 to allow the display system 150 to store the extracted aging information in the memory 106. During subsequent programming and/or emission operations of the pixel 110, the aging information is retrieved from the memory 106 by the controller 102 via memory signals 136, and the controller 102 then compensates for the extracted degradation information in subsequent programming and/or emission operations of the pixel 110. For example, once the degradation information is extracted, the programming information conveyed to the pixel 110 via the data line 122 can be appropriately adjusted during a subsequent programming operation of the pixel 110 such that the pixel 110 emits light with a desired amount of luminance that is independent of the degradation of the pixel 110. In an example, an increase in the threshold voltage of the driving transistor within the pixel 110 can be compensated for by appropriately increasing the programming voltage applied to the pixel 110.

Over and above calibration, which can be implemented on a pixel by pixel basis, an overall brightness of the display panel 120 is controlled in response to monitored temperature and aging, in order to manage and control temperatures and aging of the display. In embodiments that follow, typically a controller 102 of the display system 150 directs the monitor system 112 to take measurements of temperature and aging, saves to and retrieves from the memory store 106 data indicative of temperature and aging and perform the various processes to determine how management of the overall brightness of the display is to occur.

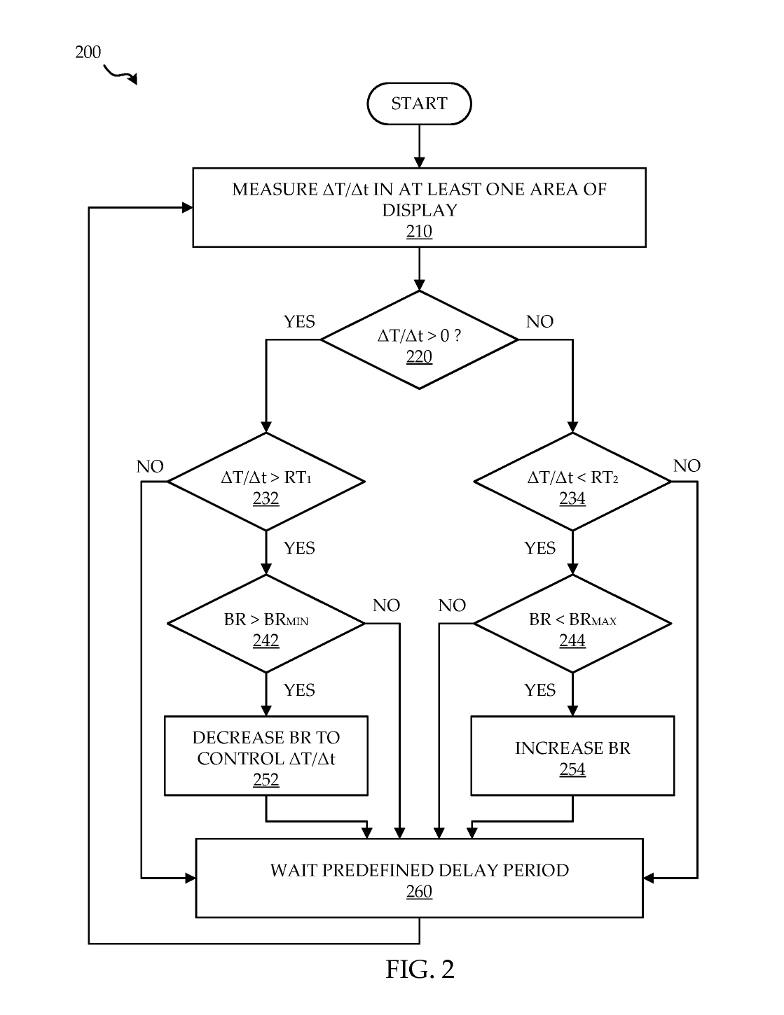

Referring to FIG. 2, a method employed by the display system 150 for management of temperature stability, aging, and optimal brightness through brightness control will now be described. The method 200 controls display aging and temperature by adjusting the display brightness based on the rate of change in measured or estimated temperature ΔT/Δt of at least one display area. The temperature change ΔT/Δt of at least one area of the display panel 120 is measured or estimated 210 and the display brightness is controlled by the rate of change in the temperature as follows. If the rate of increase in the temperature is faster than a defined threshold rate RT₁, i.e. if ΔT/Δt>0 and ΔT/Δt>RT₁, 220 232 the display brightness BR is adjusted 252 to stabilize the display temperature and in this particular embodiment is reduced 252 when the brightness BR is above a predefined minimum brightness BR_{MIN} 242. If the measured temperature is decreasing and optionally below a negative threshold rate RT₂ 234 and there is headroom left for increasing the display brightness i.e. the brightness BR is less than a defined maximum brightness BR_{MAX} 244, the display brightness can increase until the temperature stabilizes. In general the display brightness is controlled to stay within a defined minimum brightness BR_{MIN} and a defined maximum brightness BR_{MAX}. After adjustment of the brightness or if the rate of temperature change is between the thresholds (i.e. RT₂<ΔT/Δt<RT₁) or if the brightness cannot be increased 244 or decreased 242 due to the defined maximum or minimum brightness threshold having been met, then the system waits for a predefined waiting period 260 before making a subsequent temperature measurement or estimate 210.

The temperature changing rate ΔT/Δt of more areas in the display panel 120 can be measured or estimated (also a temperature changing rate profile of the entire display panel 120 can be created) and different methods can be used for making decisions in the flowchart. It should be noted that measuring the temperature changing rate ΔT/Δt can be achieved by measuring the temperature T at various discrete times or continuously over time or alternatively by monitoring some quantity or property which directly varies with ΔT/Δt.

In one case, if one point or pixel of the display panel 120 has a temperature-changing rate ΔT/Δt higher or lower than a threshold value, proper steps can be taken as described. In another case, the temperature-changing rate ΔT/Δt of an accumulative area (e.g., number of pixels) larger than a predefined size should satisfy the condition before taking the proper steps. The multi-point (or area) measurement (or estimation) can be applied to all the methods described in this document and known decision making mechanisms can be utilized in the multi-point measurement (or estimation) in cooperation with the methods herein described.

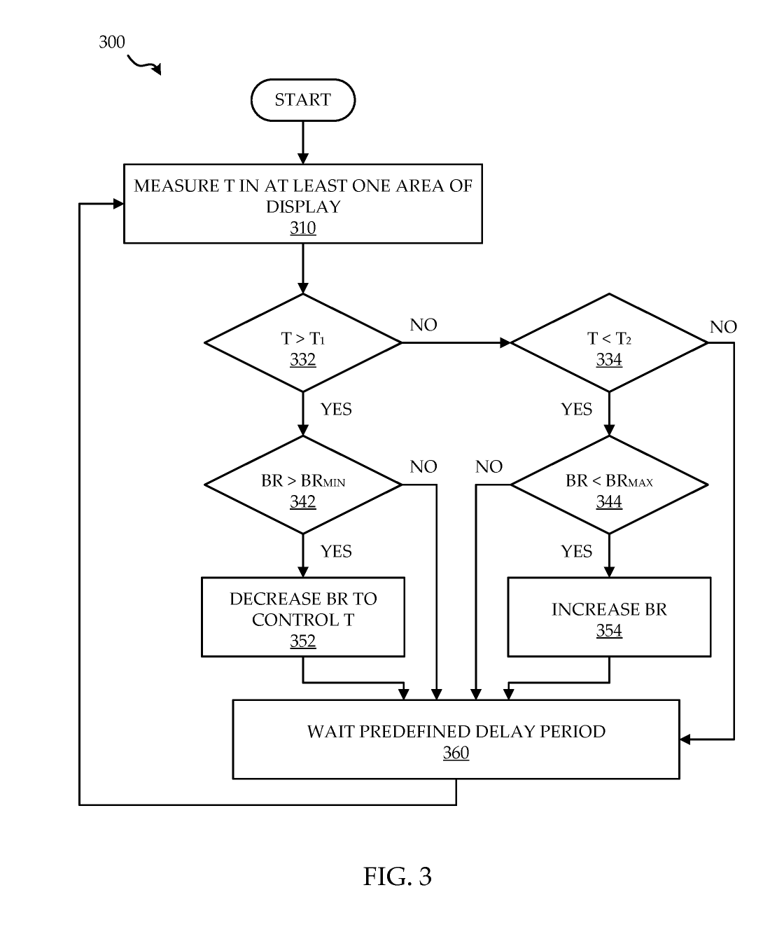

Referring now to FIG. 3, a method employed by the display system 150 for management of absolute temperature, aging, and optimal brightness through brightness control, will now be described. Here the display system 150 utilizes a method 300 of controlling display aging and temperature by adjusting the display brightness based on measured or estimated absolute temperatures T of at least one display area. The temperature T of at least one area of the display panel 120 is measured or estimated 310 and said temperature value controls the brightness of the display as follows. If the measured display temperature T is higher than a threshold T₁ 332, the display brightness is dropped 352 until the temperature T drops below the threshold T₁ or the brightness BR hits the minimum allowable value BR_{MIN} 342. If the temperature T is below the threshold (optionally a second threshold T₂) 334, the brightness can increase 352 until the temperature is higher than a given threshold (T₁ or T₂) or the brightness hits the maximum allowable value BR_{MAX} 344. After adjustment of the brightness, or if the temperature T is between the thresholds (i.e., T₂<T<T₁) or if the brightness cannot be increased 344 or decreased 342 due to the defined maximum or minimum brightness threshold having been met, then the system waits for a predefined waiting period 360 before making a subsequent temperature measurement or estimate 310.

In all the methods in this document, different threshold ranges and different adjustment mechanism can be used for each region. For example, if the temperature is really high the decrease adjustment to BR 352 can be performed with a larger correction factor to reduce the time required to bring the temperature or aging within a controlled range.

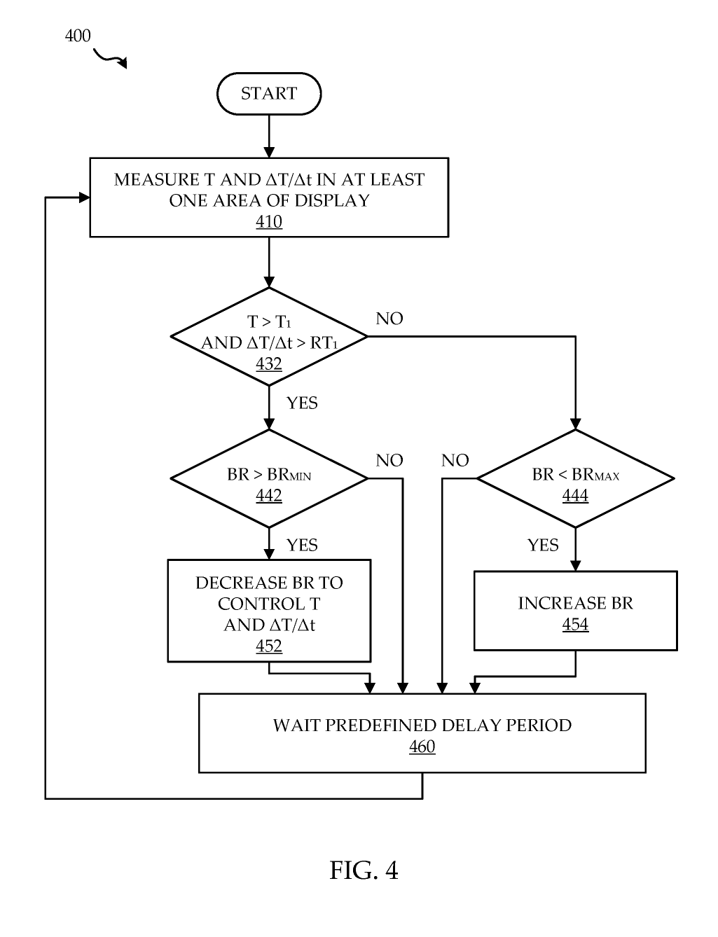

Referring to FIG. 4, a method employed by the display system 150 for management of temperature stability, absolute temperature, aging, and optimal brightness through brightness control will now be described.

Here the display system 150 utilizes a method 400 for controlling display aging or temperature by adjusting the display brightness based on measured or estimated temperature T and the measured or estimated rate of change in the temperature ΔT/Δt 410 of at least one area of the display panel 120. In one approach if the absolute temperature is higher than a threshold T₁ and the rate of change ΔT/Δt indicates that the temperature will stay at existing levels or increase further or the rate of temperature reduction is slower than a threshold (this threshold can be a given parameters or can be calculated based on maximum allowable time for display operation at high temperature), in other words, if ΔT/Δt is greater than some threshold rate RT₁ 432 the display brightness will be reduced 452 until the temperature is stabilized (and/or goes below a threshold level) or the display brightness hits the minimum allowable brightness 442. If on the other hand T>T1 and ΔT/Δt>RT₁ is not the case, then staying within the defined maximum brightness threshold BR_{MAX} 444, the brightness is optimized through increases 454. After adjustment of the brightness, or if the brightness cannot be increased 444 or decreased 442 due to the defined maximum or minimum brightness threshold having been met, then the system waits for a predefined waiting period 460 before making a subsequent temperature measurement or estimate 410.

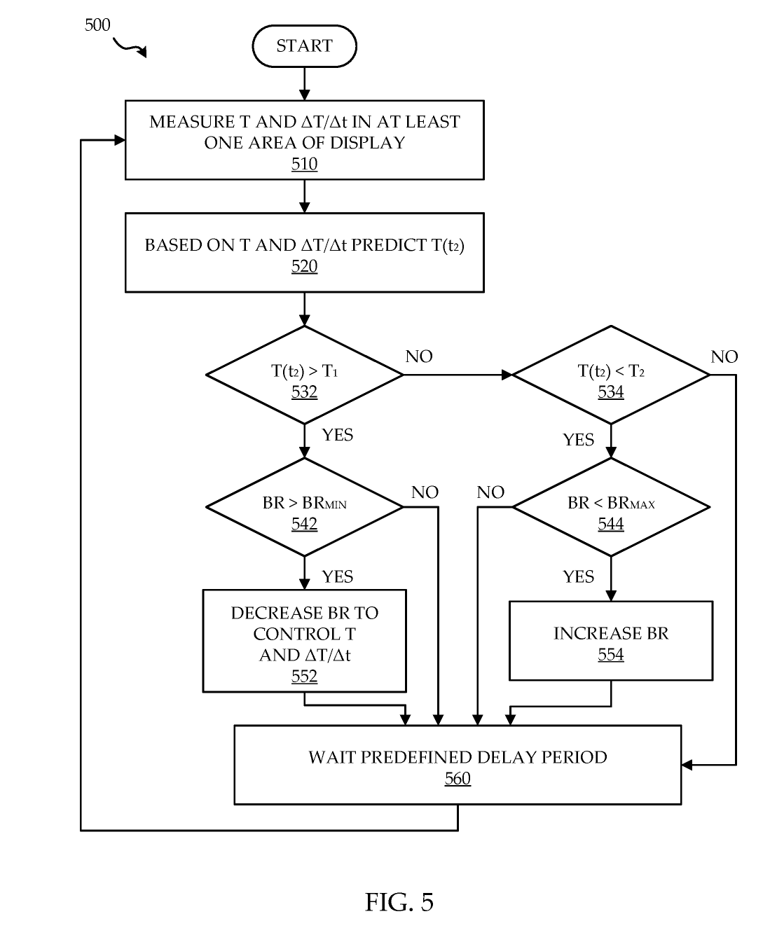

Referring also to FIG. 5, a method employed by the display system 150 for management of aging and optimal brightness while avoiding overheating through predictive analysis and brightness control will now be described. Here, the display system 150 implements a method 500 to adjust the display brightness 552 to eliminate overheating if the measured rate of change and absolute value of temperature 510 indicates 520 that the display temperature will pass a given threshold T₁ 532. In other words, if the brightness BR is smaller than a minimum allowable brightness BR_{MIN} 542 and temperature absolute value T and its rate of change ΔT/Δt shows 520 that the temperature will (for example at time t₂) be greater than a threshold T₁ the brightness can be decreased 552 to avoid the risk of overheating. In a similar manner, to optimize brightness as circumstances allow, if the brightness BR is smaller than a maximum allowable brightness BR_{MAX} 544 and temperature absolute value T and its rate of change ΔT/Δt shows 520 that the temperature will (at time t₂) be lower than a threshold T₂ 532 the brightness can be increased 554 to improve the image quality without the risk of overheating. After adjustment of the brightness, or if the temperature T(t₂) is predicted to fall between the thresholds (i.e. T₂<T(t₂)<T₁) or if the brightness cannot be increased 554 or decreased 552 due to the defined maximum or minimum brightness thresholds having been met, then the system waits for a predefined waiting period 560 before making a subsequent temperature measurement or estimate 510.

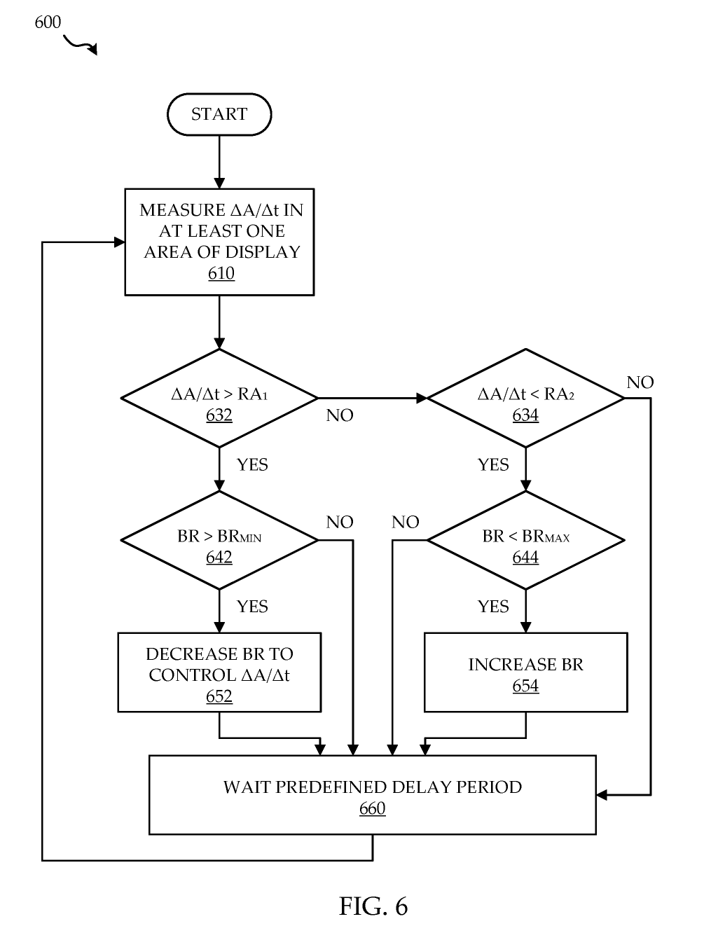

Referring to FIG. 6 a method employed by the display system 150 for management of the aging rate and optimal brightness through brightness control will now be described. Here, the display system 150 utilizes a method 600 for controlling display aging by adjusting the display brightness based on the rate of change in measured or estimated aging ΔA/Δt of at least one display area. The aging rate ΔA/Δt of at least one area of the display panel 120 is measured or estimated 610 and the display brightness is controlled by the rate of said aging as follows. If the aging rate ΔA/Δt is faster than a defined threshold rate RA₁ 632, the display brightness BR is adjusted 652 to stabilize the display aging. In other words if ΔA/Δt is greater than the threshold rate RA₁ 632 the display brightness will be reduced 652 towards values which will stabilize the aging rate if the display brightness is above the minimum allowable brightness 642 such that it can be reduced. If the measured aging rate ΔA/Δt is lower than a threshold rate RA₂ 634 and there is headroom left for increasing the display brightness or the brightness BR is less than a defined maximum brightness BR_{MAX} 644, the display brightness can increase 654 until the display-aging rate is within the defined thresholds. After adjustment of the brightness or if the rate of aging is between the thresholds (i.e., RA₂<ΔA/Δt<RA₁) or if the brightness cannot be increased 644 or decreased 642 due to the defined maximum or minimum brightness threshold having been met, then the system waits for a predefined waiting period 660 before making a subsequent temperature measurement or estimate 610.

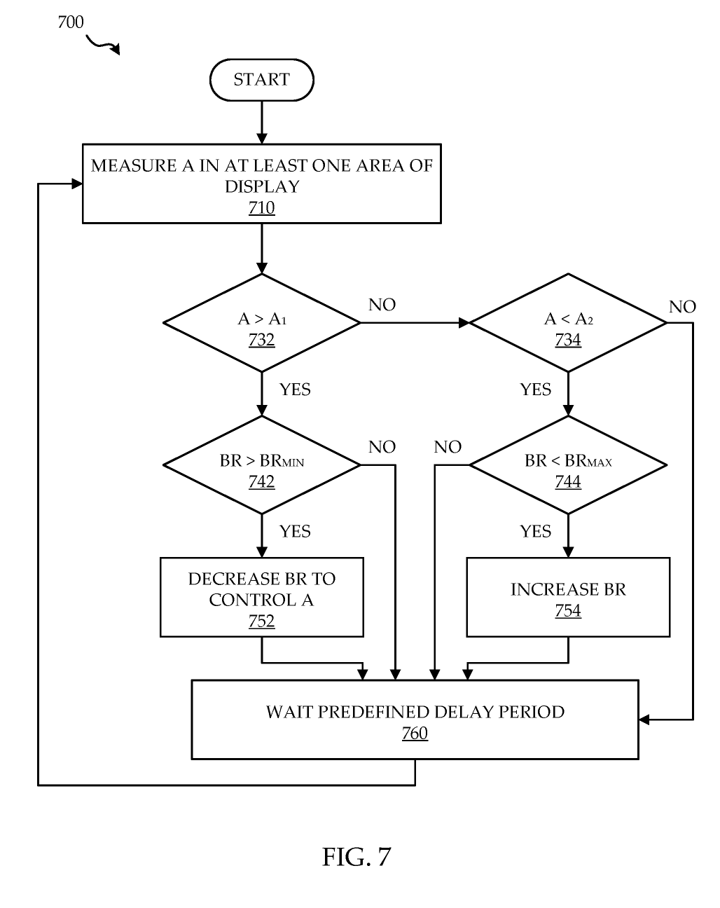

FIG. 7 illustrates an equivalent method performed by the display system 150 for management of absolute aging. Here, the display system 150 utilizes a method 700 for controlling display aging by adjusting the display brightness based on the measured or estimated aging A of at least one display area. The aging A of at least one area of the display panel 120 is measured or estimated 610 and the display brightness is controlled by the measured aging as follows. If the aging A is beyond a defined threshold A₁ 732, the display brightness BR is adjusted (here reduced) 752 if the display brightness BR is above the minimum allowable brightness BR_{MIN} 742. If the measured aging A is less than a threshold A₂ 734 and there is headroom left for increasing the display brightness or the brightness BR is less than a defined maximum brightness BR_{MAX} 744, the display brightness can increase 754 until the display-aging is within the defined thresholds. After adjustment of the brightness or if the aging is between the thresholds (i.e., A₂<A<A₁) or if the brightness cannot be increased 744 or decreased 742 due to the defined maximum or minimum brightness threshold having been met, then the system waits for a predefined waiting period 760 before making a subsequent temperature measurement or estimate 710.

It should be noted that measuring the aging rate ΔA/Δt can be achieved by measuring the aging A at various discrete times or continuously over time or alternatively by monitoring some quantity or property which directly varies with ΔA/Δt, and that measuring aging can be achieved by measuring various properties of the display indicative of aging, calculating aging from various measured properties which are together indicative of aging, and with possible use of historical or saved data stored for retrieval and periodic calculation of the aging.

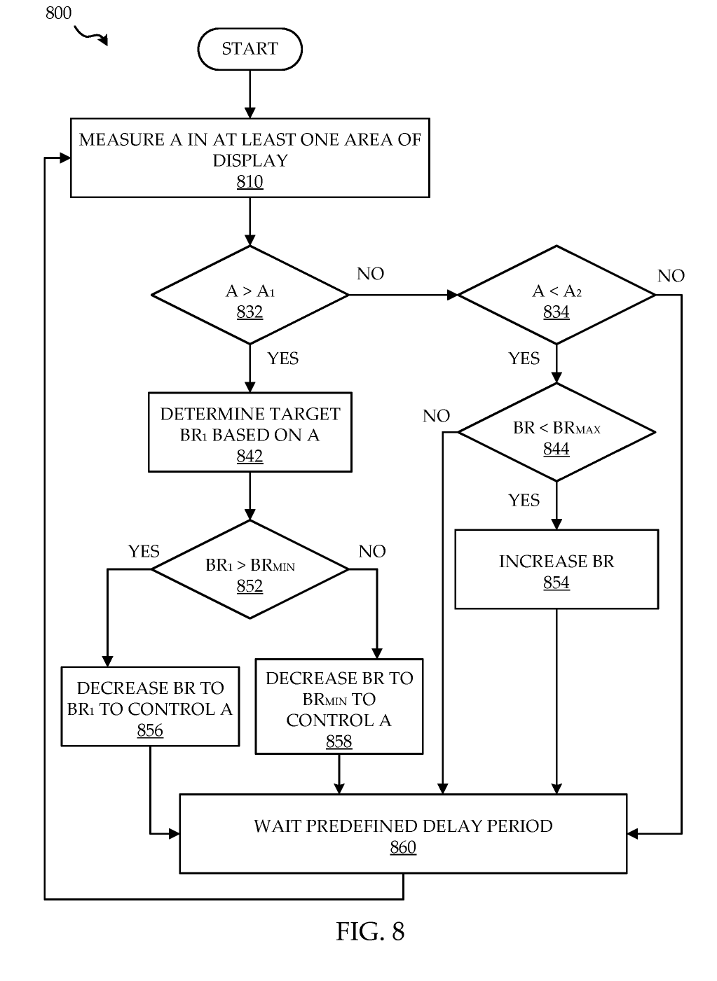

Referring to FIG. 8, another method employed by the display system 150 for management of absolute aging and optimal brightness through brightness control will now be described. Here, the system 150 utilizes a method 800 for controlling display aging by adjusting the display brightness based on measured or estimated aging A of at least one display area as follows. The aging A of at least one area of the display panel 120 is measured or estimated 810, and the aging value controls the brightness of the display, as follows. If the measured display aging A is higher than a threshold A₁ 832, the display brightness is dropped based on a predefined function which determines a target brightness BR₁ 842. The function uses any combination of the aging value, the number of pixels where the aging value is higher than the threshold, the display lifetime, display setting parameters, and other empirical parameters. In one case, the display aging is converted to display brightness. The aging rate required to meet the display lifetime is calculated. Here one easy method is to subtract the 50% by calculated brightness loss and divide it over the remaining lifetime requirement. Based on user profile information, the brightness that can achieve the remaining of display lifetime is calculated, and chosen as the current target brightness BR₁. In one case, the calculated brightness BR₁ can be compared with a minimum brightness BR_{MIN} setting 852, and the higher of two will be used as new display brightness 856, 858. To optimize brightness as circumstances allow, if the brightness BR is smaller than a maximum allowable brightness BR_{MAX} 844 and the aging value A is lower than a threshold A₂ 834 the brightness can be increased 854 to improve the image quality under conditions of acceptable aging. After adjustment of the brightness or if the aging is between the thresholds (i.e. A₂<A<A₁) or if the brightness cannot be increased 844 due to the defined maximum or minimum brightness threshold having been met, then the system waits for a predefined waiting period 860 before making a subsequent temperature measurement or estimate 810.

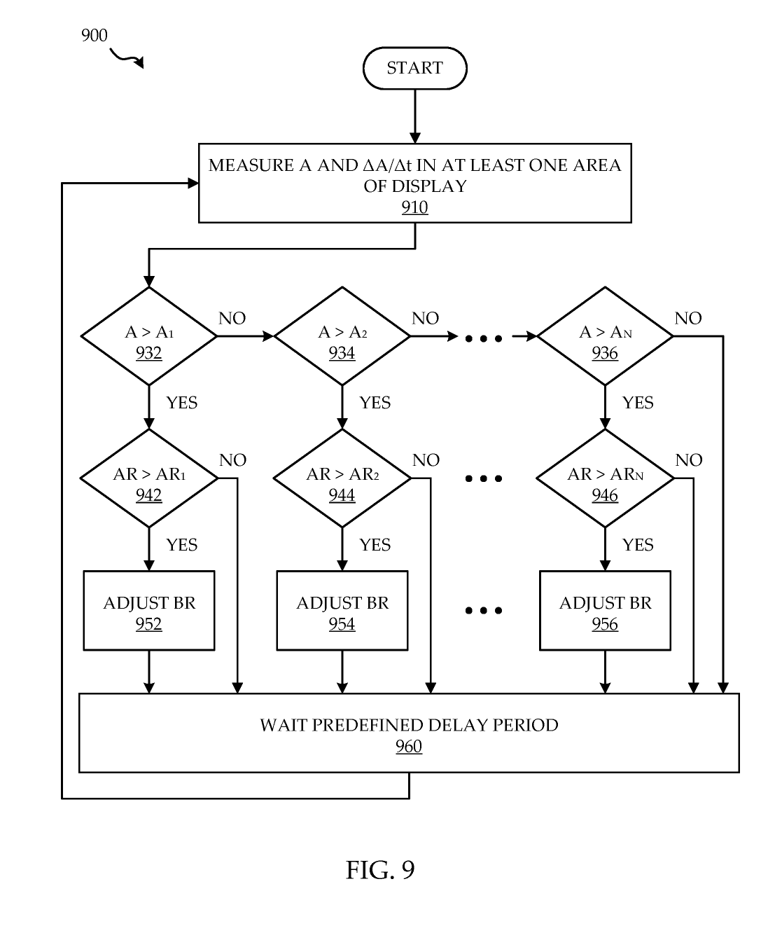

Referring to FIG. 9, a further method employed by the display system 150 for management of absolute aging and optimal brightness through brightness control will now be described. Here, the system 150 utilizes a method for controlling display aging by adjusting the display brightness based on measured or estimated aging A and the rate of aging ΔA/Δt of at least one area 910 as follows. In one approach the function to adjust the display brightness is a function of both absolute aging value A and rate of aging ΔA/Δt and associated thresholds A₁ and AR₁ 932 942. In one case, the brightness can be a set 952 of linear functions within different regions which are separated by threshold values for aging (A₁, A₂, . . . A_{N}) and the rate of aging (AR₁, AR₂, . . . AR₃). Within each region shown as 1, 2, up to N, the absolute aging A is compared 932, 934, 936 with a threshold for the region (A₁, A₂, . . . A_{N}) and the aging rate AR is compared 942, 944, 946 with a threshold for the region (AR₁, AR₂, . . . AR_{N}), and if both thresholds are exceeded, the brightness BR is adjusted 952, 954, 956. If none of the threshold tests are not met, or after adjustment of brightness BR, the system waits for a predefined waiting period 960 before making a subsequent aging or aging rate measurement or estimate 910.

In another embodiment which is a variation to that depicted in FIG. 7, the brightness is adjusted to keep the aging A lower than a threshold value A₁ and aging controls said threshold value. For example, if the aging value increases, said threshold value decreases. The adjustment of the threshold value can be function of display lifetime, and other parameters.

In all the above methods, the minimum and maximum brightness can be set by other factors such as display specifications, application, user setting, and other environmental factors such as environmental brightness.

Any number of the above methods can be used in the display as independent functions and combined. As such, the final display brightness can be controlled by any or all of the above methods. In one embodiment, each method calculates the required brightness and the minimum value from the set of calculated values for brightness is selected. After that, the display brightness is set to the higher of that selected brightness or the minimum allowable brightness.

As described for the above methods, the measurement or estimation of the temperature and aging can occur on a periodic basis, each delay period being set depending upon the particular kind of measurements made and optionally on how the display is responding to management. In general, since the display temperature or aging (absolute or rate values) response to changing brightness is slow, the timing interval for measurement (or estimation), in some embodiments, the time constant of the response is taken into account to avoid oscillation and instability in the above methods. For example, to ensure the effect of any change in brightness is settled, the measurement interval or delay period can be set to be larger than the time constant of the display temperature or aging response. In other embodiments, the measurement interval can be faster than the time constant of the said display response. For these embodiments, the method follows the change in each type of measurement and if the change between two consecutive measurements is less than a threshold then those values are used for adjusting the brightness based on the aforementioned methods. Any another embodiment, the change between more than two consecutive measurements can be used and if the rate of change is stable, then one of those measurements is used for adjusting the display brightness based on at least one of the abovementioned methods.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method of adjusting a brightness of an emissive display system:
periodically measuring at least one physical property in at least one area of a display panel generating measurement data; and
adjusting the brightness of the display panel with use of the measurement data.

2. The method of claim 1, wherein the measurement data comprises measurements of each at least one physical property, the method further comprising:
comparing each measurement of each at least one physical property with at least one threshold generating a respective at least one comparison,
wherein adjusting the brightness of the display panel is performed with use of the at least one comparison.

3. The method of claim 1 further comprising:
predicting the future state of at least one physical property with use of the measurement data generating at least one predicted physical property value; and
comparing the at least one predicted physical property value with at least one threshold generating a respective at least one comparison,
wherein adjusting the brightness of the display panel is performed with use of the at least one comparison.

4. The method of claim 2, wherein adjusting the brightness of the display panel comprises determining a target brightness for the display panel with use of the measurement data, wherein the target brightness falls within at least one acceptable range of brightness.

5. The method of claim 3, wherein adjusting the brightness of the display panel comprises determining a target brightness for the display panel with use of the measurement data, wherein the target brightness falls within at least one acceptable range of brightness.

6. The method of claim 4, wherein the at least one physical property comprises a rate of temperature change and the at least one threshold comprises a first threshold rate of temperature change and a second threshold rate of temperature change, wherein adjusting the brightness of the display panel comprises:
determining the target brightness to be lower than a current brightness when the at least one comparison indicates that the rate of temperature change is greater than the first threshold rate of temperature change and when the current brightness is greater than a minimum acceptable brightness of said at least one acceptable range of brightness; and
determining the target brightness to be higher than the current brightness when the at least one comparison indicates that the rate of temperature change is less than the second threshold rate of temperature change, and when the current brightness is less than a maximum acceptable brightness of said at least one acceptable range of brightness.

7. The method of claim 4, wherein the least one physical property comprises a temperature and the at least one threshold comprises a first threshold temperature and a second threshold temperature, wherein adjusting the brightness of the display panel comprises:
determining the target brightness to be lower than a current brightness when the at least one comparison indicates that the temperature is greater than the first threshold temperature and when the current brightness is greater than a minimum acceptable brightness of said at least one acceptable range of brightness; and
determining the target brightness to be higher than the current brightness when the at least one comparison indicates that the temperature is less than the second threshold temperature, and when the current brightness is less than a maximum acceptable brightness of said at least one acceptable range of brightness.

8. The method of claim 4, wherein the at least one physical property comprises a rate of temperature change and a temperature and the at least one threshold comprises a threshold rate of temperature change a threshold temperature, wherein adjusting the brightness of the display panel comprises:
determining the target brightness to be lower than a current brightness when the at least one comparison indicates that the rate of temperature change is greater than the threshold rate of temperature change and the temperature is greater than the threshold temperature and when the current brightness is greater than a minimum acceptable brightness of said at least one acceptable range of brightness; and
determining the target brightness to be higher than the current brightness when the at least one comparison indicates that at least one of the rate of temperature change is not greater than the threshold rate of temperature change and the temperature is not greater than the threshold temperature, and when the current brightness is less than a maximum acceptable brightness of said at least one acceptable range of brightness.

9. The method of claim 5, wherein the at least one physical property comprises a rate of temperature change and a temperature, the at least one predicted physical property value comprises a predicted temperature value, and the at least one threshold comprises a first threshold temperature and a second threshold temperature, wherein adjusting the brightness of the display panel comprises:
determining the target brightness to be lower than a current brightness when the at least one comparison indicates that the predicted temperature value is greater than the first threshold temperature and when the current brightness is greater than a minimum acceptable brightness of said at least one acceptable range of brightness; and
determining the target brightness to be higher than the current brightness when the at least one comparison indicates that the predicted temperature value is less than the second threshold temperature, and when the current brightness is less than a maximum acceptable brightness of said at least one acceptable range of brightness.

10. The method of claim 4, wherein the at least one physical property comprises a rate of aging and the at least one threshold comprises a first threshold rate of aging and a second threshold rate of aging, wherein adjusting the brightness of the display panel comprises:
determining the target brightness to be lower than a current brightness when the at least one comparison indicates that the rate of aging is greater than the first threshold rate of aging and when the current brightness is greater than a minimum acceptable brightness of said at least one acceptable range of brightness; and
determining the target brightness to be higher than the current brightness when the at least one comparison indicates that the rate of aging is less than the second threshold rate of aging, and when the current brightness is less than a maximum acceptable brightness of said at least one acceptable range of brightness.

11. The method of claim 4, wherein the at least one physical property comprises aging and the at least one threshold comprises a first threshold aging and a second threshold aging, wherein adjusting the brightness of the display panel comprises:
determining the target brightness to be lower than a current brightness when the at least one comparison indicates that the aging is greater than the first threshold aging and when the current brightness is greater than a minimum acceptable brightness of said at least one acceptable range of brightness; and
determining the target brightness to be higher than the current brightness when the at least one comparison indicates that the aging is greater than the second threshold aging, and when the current brightness is less than a maximum acceptable brightness of said at least one acceptable range of brightness.

12. The method of claim 4, wherein the at least one physical property comprises aging and a rate of aging the at least one threshold comprises a plurality of aging thresholds and a corresponding plurality of threshold aging rates, wherein adjusting the brightness of the display panel comprises:
determining the target brightness when the at least one comparison indicates that the aging is greater than the one of the plurality of aging threshold and the rate of aging is greater than the corresponding one of the plurality of threshold aging rates.

13. A display system comprising:
a display panel having an array of pixels that each include a drive transistor and a light emitting device, multiple select lines coupled to said array for delivering signals that select when each pixel is to be driven, multiple data lines for delivering drive signals to the selected pixels, and multiple monitor lines for conveying signals from each pixel; and
a monitor system for periodically measuring at least one physical property in at least one area of the display with use of signals over the monitor lines to pixels of the at least one area generating measurement data;
a memory store for storing the measurement data; and
a controller adapted to adjust the brightness of the display panel with use of the measurement data.

14. The display system of claim 13, wherein the measurement data comprises measurements of each at least one physical property, the controller further adapted to:
compare each measurement of each at least one physical property with at least one threshold generating a respective at least one comparison,
wherein the controller is adapted to adjust the brightness of the display panel with use of the at least one comparison.

15. The display system of claim 13, wherein the controller is further adapted to:
predict the future state of at least one physical property with use of the measurement data generating at least one predicted physical property value; and
compare the at least one predicted physical property value with at least one threshold generating a respective at least one comparison,
wherein the controller is adapted to adjust the brightness of the display panel with use of the at least one comparison.

16. The display system of claim 14, wherein the controller is adapted to adjust the brightness of the display panel by determining a target brightness for the display panel with use of the measurement data, wherein the target brightness falls within at least one acceptable range of brightness.

17. The display system of claim 15, wherein the controller is adapted to adjust the brightness of the display panel by determining a target brightness for the display panel with use of the measurement data, wherein the target brightness falls within at least one acceptable range of brightness.

18. The display system of claim 16, wherein the at least one physical property comprises a rate of temperature change and the at least one threshold comprises a first threshold rate of temperature change and a second threshold rate of temperature change, wherein the controller is adapted to adjust the brightness of the display panel by:
determining the target brightness to be lower than a current brightness when the at least one comparison indicates that the rate of temperature change is greater than the first threshold rate of temperature change and when the current brightness is greater than a minimum acceptable brightness of said at least one acceptable range of brightness; and
determining the target brightness to be higher than the current brightness when the at least one comparison indicates that the rate of temperature change is greater than the second threshold rate of temperature change, and when the current brightness is less than a maximum acceptable brightness of said at least one acceptable range of brightness.

19. The display system of claim 16, wherein the at least one physical property comprises a temperature and the at least one threshold comprises a first threshold temperature and a second threshold temperature, wherein the controller is adapted to adjust the brightness of the display panel by:
determining the target brightness to be lower than a current brightness when the at least one comparison indicates that the temperature is greater than the first threshold temperature and when the current brightness is greater than a minimum acceptable brightness of said at least one acceptable range of brightness; and
determining the target brightness to be higher than the current brightness when the at least one comparison indicates that the temperature is greater than the second threshold temperature, and when the current brightness is less than a maximum acceptable brightness of said at least one acceptable range of brightness.

20. The display system of claim 16, wherein the at least one physical property comprises a rate of temperature change and a temperature and the at least one threshold comprises a threshold rate of temperature change a threshold temperature, wherein the controller is adapted to adjust the brightness of the display panel by:
determining the target brightness to be lower than a current brightness when the at least one comparison indicates that the rate of temperature change is greater than the threshold rate of temperature change and the temperature is greater than the first threshold temperature and when the current brightness is greater than a minimum acceptable brightness of said at least one acceptable range of brightness; and
determining the target brightness to be higher than the current brightness when the at least one comparison indicates that at least one of the rate of temperature change is not greater than the threshold rate of temperature change and the temperature is not greater than the second threshold temperature, and when the current brightness is less than a maximum acceptable brightness of said at least one acceptable range of brightness.

21. The display system of claim 17, wherein the at least one physical property comprises a rate of temperature change and a temperature, the at least one predicted physical property value comprises a predicted temperature value, and the at least one threshold comprises a first threshold temperature and a second threshold temperature, wherein the controller is adapted to adjust the brightness of the display panel by:
determining the target brightness to be lower than a current brightness when the at least one comparison indicates that the predicted temperature value is greater than the first threshold temperature and when the current brightness is greater than a minimum acceptable brightness of said at least one acceptable range of brightness; and
determining the target brightness to be higher than the current brightness when the at least one comparison indicates that the predicted temperature value is not greater than the second threshold temperature, and when the current brightness is less than a maximum acceptable brightness of said at least one acceptable range of brightness.

22. The display system of claim 16, wherein the at least one physical property comprises a rate of aging and the at least one threshold comprises a first threshold rate of aging and a second threshold rate of aging, wherein the controller is adapted to adjust the brightness of the display panel by:
determining the target brightness to be lower than a current brightness when the at least one comparison indicates that the rate of aging is greater than the first threshold rate of aging and when the current brightness is greater than a minimum acceptable brightness of said at least one acceptable range of brightness; and
determining the target brightness to be higher than the current brightness when the at least one comparison indicates that the rate of aging is greater than the second threshold rate of aging, and when the current brightness is less than a maximum acceptable brightness of said at least one acceptable range of brightness.

23. The display system of claim 16, wherein the at least one physical property comprises aging and the at least one threshold comprises a first threshold aging and a second threshold aging, wherein the controller is adapted to adjust the brightness of the display panel by:
determining the target brightness to be lower than a current brightness when the at least one comparison indicates that the aging is greater than the first threshold aging and when the current brightness is greater than a minimum acceptable brightness of said at least one acceptable range of brightness; and
determining the target brightness to be higher than the current brightness when the at least one comparison indicates that the aging is greater than the second threshold aging, and when the current brightness is less than a maximum acceptable brightness of said at least one acceptable range of brightness.

24. The display system of claim 16, wherein the at least one physical property comprises aging and a rate of aging the at least one threshold comprises a plurality of aging thresholds and a corresponding plurality of threshold aging rates, wherein the controller is adapted to adjust the brightness of the display panel by determining the target brightness when the at least one comparison indicates that the aging is greater than the one of the plurality of aging threshold and the rate of aging is greater than the corresponding one of the plurality of threshold aging rates.
